(19) United States
(12) Patent Application Publication
(10) Pub. No.: US 2026/0232514 A1
(43) Pub. Date: Aug. 13, 2026

(54) REHABILITATION TRAINING METHOD FOR A REHABILITATION ROBOT FOR RESTORING UPPER MUSCULOSKELETAL FUNCTION, AND A METHOD FOR SETTING REHABILITATION TREATMENT ANGLES OF A PLURALITY OF JOINT PORTIONS OF AN UPPER LIMB REHABILITATION ROBOT

(71) Applicant: Hexar Robotics Co., Ltd, Ansan-si (KR)

(72) Inventor: Young Hoon JI, Ansan-si (KR)

(73) Assignee: Hexar Robotics Co., Ltd, Ansan-si (KR)

(21) Appl. No.: 19/645,034

(22) Filed: Apr. 10, 2026

Related U.S. Application Data
(63) Continuation of application No. PCT/KR2024/009438, filed on Jul. 4, 2024.

(30) Foreign Application Priority Data
Jul. 4, 2023 (KR) 10-2023-0086194
Jul. 4, 2023 (KR) 10-2023-0086195

(51) Int. Cl. A61H 1/02; B25J 9/00; B25J 13/08

(52) U.S. Cl. CPC A61H 1/0274; B25J 9/0006; B25J 13/085; B25J 13/088; A61H 2201/165; A61H 2201/1659; A61H 2201/5061

(57) ABSTRACT

A method includes (a) preparing a rehabilitation robot including at least two joint portions, body wearing portions connected by the joint portions, actuators configured to rotate the body wearing portions about the joint portions, sensor modules configured to measure joint torque generated by an external force applied by an operator or a patient, and a controller configured to control operation of the actuators; (b) applying, by the operator, an external force to the robot to move the robot to a desired posture; (c) collectively storing, in the controller through an external interface, angle values measured at the joint portions in the set posture; (d) repeating steps (b) and (c) to store angle values at two or more different postures; (e) automatically generating a motion profile for a linking operation between the stored postures; and (f) performing a rehabilitation operation by operating the rehabilitation robot according to the generated motion profile.

### CROSS-REFERENCE TO RELATED APPLICATIONS

This application is a bypass continuation of International Application No. PCT/KR2024/009438, filed on Jul. 4, 2024, which claims priority under 35 U.S.C. § 119(a) to Korean Patent Application No. 10-2023-0086194, filed on Jul. 4, 2023, and Korean Patent Application No. 10-2023-0086195, filed on Jul. 4, 2023. The entire contents of the above-identified applications are hereby incorporated by reference.

### BACKGROUND OF THE INVENTION

### 1. Field of the Invention

The present disclosure relates to a rehabilitation training method for a rehabilitation robot for restoring upper musculoskeletal function and a method for setting rehabilitation treatment angles of a plurality of joint portions of an upper limb rehabilitation robot, wherein, in a state in which a patient wears the rehabilitation robot, an operator directly moves the plurality of joint portions to set a trainable joint range of motion of the patient, and angle values measured at the plurality of joint portions are collectively stored in a controller, thereby enabling intuitive capture of rehabilitation operations, and enabling linking operations and repetitive rehabilitation training among a plurality of rehabilitation operations captured by the controller, and more particularly relates to a rehabilitation training method for a rehabilitation robot for restoring upper musculoskeletal function and a method for setting rehabilitation treatment angles of a plurality of joint portions of an upper limb rehabilitation robot in which, in a state in which a patient wears the rehabilitation robot, an operator directly moves the plurality of joint portions to set a trainable joint range of motion of the patient and angle values measured at the plurality of joint portions are collectively stored in the controller.

### 2. Description of the Related Art

In general, a joint portion of a patient may become weakened or stiffened when it is not moved for a long period of time due to an accident, surgery, or the like, and thus continuous rehabilitation exercise is required, and in particular, it is important to determine an intensity and a method of rehabilitation exercise according to a condition of each patient to provide a patient-specific rehabilitation protocol.

However, in a conventional method for providing a rehabilitation protocol using a joint rehabilitation exercise apparatus, a condition of a patient, particularly a range of motion of a joint of the patient, is measured by a doctor or a rehabilitation therapist by directly moving the joint of the patient by hand or visually measuring the same, resulting in low accuracy, and since the doctor or the rehabilitation therapist directly performs the measurement, there is a problem in that a large amount of time and cost is required.

In addition, since the range of motion of the joint may vary depending on the doctor or the rehabilitation therapist who measures the range of motion, or depending on surrounding conditions or situations, reliability is very low, and thus there is a problem in that a rehabilitation effect is degraded.

As a prior art for solving such problems, Korean Patent No. 10-2451159 entitled “joint rehabilitation exercise apparatus” has been proposed.

FIG. 1 is a diagram schematically illustrating a joint rehabilitation exercise apparatus for providing a patient-specific rehabilitation protocol according to the related art.

As shown in FIG. 1, in a joint rehabilitation exercise apparatus for rotating a joint of a human body according to the related art, the apparatus includes a first body wearing portion 112 configured to support one side of the joint; a second body wearing portion 113 rotatably coupled to the first body wearing portion 112 and configured to support the other side of the joint; an actuator 111 configured to rotate the second body wearing portion 113 with respect to the first body wearing portion 112; a sensing portion 121 configured to measure a magnitude of a current applied to the actuator 111 or to measure a load generated by the actuator 111; and a controller 120 configured to store, in a memory, an angle between the first body wearing portion 112 and the second body wearing portion 113 when a difference between a magnitude of the current applied to the actuator 111 and an initial current value of the actuator 111 or a difference between a magnitude of the load generated by the actuator 111 and an initial load value of the actuator 111 reaches a preset target value when the joint is maximally bent or maximally extended.

The apparatus further includes a stop button configured to stop operation of the actuator 111, wherein, when the stop button is operated, rotation of the second body wearing portion 113 is stopped even when the difference in current value or the difference in load does not reach the preset target value, and an angle between the first body wearing portion 112 and the second body wearing portion 113 at a time when the stop button is operated is stored in the memory 123, and the apparatus further includes an input portion configured to additionally input an arbitrary set angle, wherein, when the set angle is input through the input portion, the input set angle is stored in the memory 123, and a patient-specific rehabilitation protocol corresponding to a state of a patient using the joint rehabilitation exercise apparatus 100 is generated using data stored in the memory and is provided to perform rehabilitation exercise.

However, in the above-described related art, in order to set an operation angle of a joint of a rehabilitation robot, an angle is input to a separately provided remote controller or a button attached to the joint is clicked to change the joint angle and the angle is recognized and transmitted to the remote controller or an operation portion to be input, and such a method has a disadvantage in that, when the apparatus includes a plurality of actuators, input becomes cumbersome and is not intuitive, and it is difficult to recognize what posture corresponds to an input angle.

In addition, since the rehabilitation robot according to the related art is configured to perform a simple reciprocating motion for each joint during rehabilitation exercise, it is difficult to provide efficient rehabilitation exercise because a complex motion having multiple degrees of freedom similar to actual daily life motion cannot be performed, and since one of a plurality of preset trajectory modes is selected to provide uniform rehabilitation exercise to a rehabilitation patient, there is a problem in that know-how of a rehabilitation specialist cannot be reflected.

### SUMMARY OF THE INVENTION

An object of the present disclosure is to enable intuitive capture of rehabilitation operations by allowing an operator, in a state in which a patient wears a rehabilitation robot, to directly move a plurality of joint portions to set a trainable joint range of motion of the patient, and to collectively store, in a controller, set angle values measured at the plurality of joint portions, and to enable linking operations and repetitive rehabilitation training among a plurality of rehabilitation operations captured by the controller, thereby improving efficiency of rehabilitation exercise.

Another object of the present disclosure is to provide a patient-specific rehabilitation protocol by allowing an operator having rehabilitation expertise, in a state in which a patient wears a rehabilitation robot, to manipulate joint portions of the rehabilitation robot according to a condition of the patient to check a trainable joint range of motion of the patient, thereby determining an intensity, a range, and a method of rehabilitation exercise according to the patient.

Still another object of the present disclosure is to facilitate data input operations, reduce time required for data input, and reduce costs associated therewith by collectively storing and managing angle values measured at a plurality of joint portions set to a maximum range of motion as a single set posture data value during operation of a multi-joint rehabilitation robot.

According to one aspect of the present disclosure, there is provided a rehabilitation training method for a rehabilitation robot for restoring upper musculoskeletal function, the method comprising: (a) preparing a rehabilitation robot including at least two joint portions, a plurality of body wearing portions connected by the joint portions, a plurality of actuators configured to rotate the plurality of body wearing portions about the joint portions, a plurality of sensor modules configured to measure joint torque generated by an external force applied by an operator or a patient, and a controller configured to control operation of the actuators (S10), (b) applying, by the operator, an external force to the robot to move the robot to a desired posture (S11), (c) collectively storing, in the controller through an external interface, angle values measured at the plurality of joint portions in the set posture (S12), (d) repeating steps (b) and (c) to store angle values at two or more different postures (S13), (e) automatically generating a motion profile for a linking operation between the stored postures (S14), and (f) performing a rehabilitation operation by operating the rehabilitation robot according to the generated motion profile (S15).

Here, step (b) may include performing an operator mode in which operation of the robot is performed by an external force of the operator.

Further, step (b) may include performing a patient mode in which operation of the robot is performed by a patient's own force according to guidance of the operator.

Further, in step (c), angle values measured during movement are not stored.

Further, step (f) may include selectively performing one of a forward operation mode in which the rehabilitation robot is operated according to an order of the generated motion profile and a reverse operation mode in which the rehabilitation robot is operated in a reverse order of the motion profile.

According to another aspect of the present disclosure, there is provided a method for setting rehabilitation treatment angles of a plurality of joint portions of an upper limb rehabilitation robot, the method comprising: (a) preparing a rehabilitation robot including at least two joint portions, a plurality of body wearing portions connected by the joint portions, a plurality of actuators configured to rotate the plurality of body wearing portions about the joint portions, a plurality of sensor modules configured to measure joint torque generated by an external force applied by an operator or a patient, and a controller configured to control operation of the actuators (S10), (b) performing an initialization step of calculating torque values measured by the sensor modules and setting compensation values of the actuators based on the calculated torque values (S20), (c) allowing a patient to wear the rehabilitation robot (S30), (d) checking a trainable joint range of motion of the patient while rotating the joint portions of the robot through interaction between the operator and the patient (S40), and (e) collectively storing, in the controller through an external interface, angle values measured at the plurality of joint portions when the trainable joint range of motion of the patient is determined (S50).

The rehabilitation robot may be implemented in a wearable form attachable to a body of the patient, wherein the controller is formed in a torso-shaped main body, wherein joint portions, body wearing portions, actuators, and sensor modules are provided on left and right sides of the main body corresponding to a right arm and a left arm, and wherein rehabilitation treatment is systematically performed such that left and right arms of the patient are balanced through the controller.

The rehabilitation robot may include an actuator, a sensor module, an input module, an interface, a memory, an output module, a communication module, a power module, and a controller, wherein the input module, the interface, the memory, the output module, the communication module, and the power module are integrally configured with the controller in a single case and installed in a main body of the rehabilitation robot.

Step (d) may include performing an operator mode in which operation of the robot is performed by an external force of the operator.

Step (d) may include performing a patient mode in which operation of the robot is performed by a patient's own force according to guidance of the operator.

Step (b) or step (c) may include calculating torque values measured by the sensor modules and setting compensation values of the actuators based on the torque values reflecting a variable corresponding to a body weight of the patient.

Step (b) or step (c) may include calculating torque values measured by the sensor modules and setting compensation values of the actuators based on the torque values reflecting a variable corresponding to muscle strength of the patient.

### BRIEF DESCRIPTION OF THE DRAWINGS

FIG. 1 is a diagram schematically illustrating a joint rehabilitation exercise apparatus for providing a patient-specific rehabilitation protocol according to the related art.

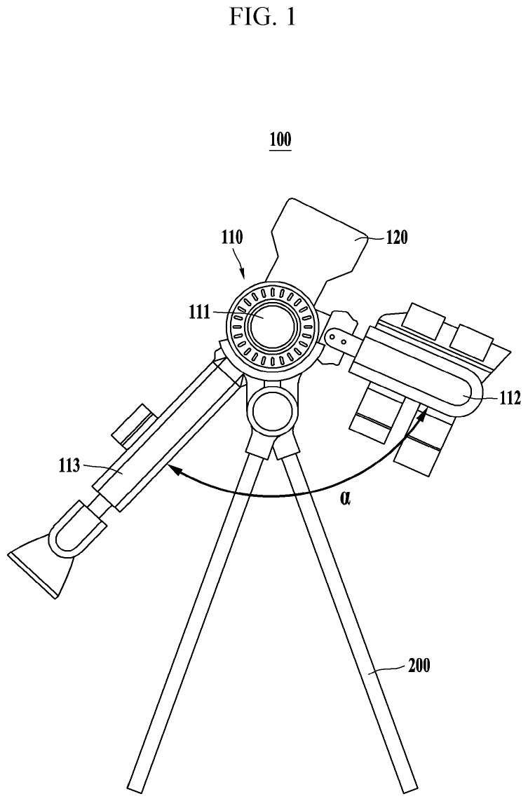

FIG. 2 is a conceptual diagram for explaining a rehabilitation robot for restoring upper musculoskeletal function according to the present disclosure.

FIG. 3 is a block diagram illustrating an operating mechanism of the rehabilitation robot for restoring upper musculoskeletal function according to the present disclosure.

FIG. 4 is a flowchart illustrating a rehabilitation training method using the rehabilitation robot according to the present disclosure.

FIG. 5 is a flowchart illustrating a method for setting rehabilitation treatment angles of a plurality of joint portions of an upper limb rehabilitation robot according to the present disclosure.

FIG. 6 is a diagram illustrating an example of a transformed robot posture.

### DETAILED DESCRIPTION OF THE INVENTION

Specific structural or functional descriptions of embodiments according to the concept of the present disclosure disclosed herein are merely exemplified for the purpose of describing the embodiments according to the concept of the present disclosure, and the embodiments according to the concept of the present disclosure may be implemented in various forms and are not limited to the embodiments described herein.

Hereinafter, embodiments will be described in detail with reference to the accompanying drawings. However, the scope of the present disclosure is not limited or restricted by these embodiments. The same reference numerals in each drawing denote the same elements.

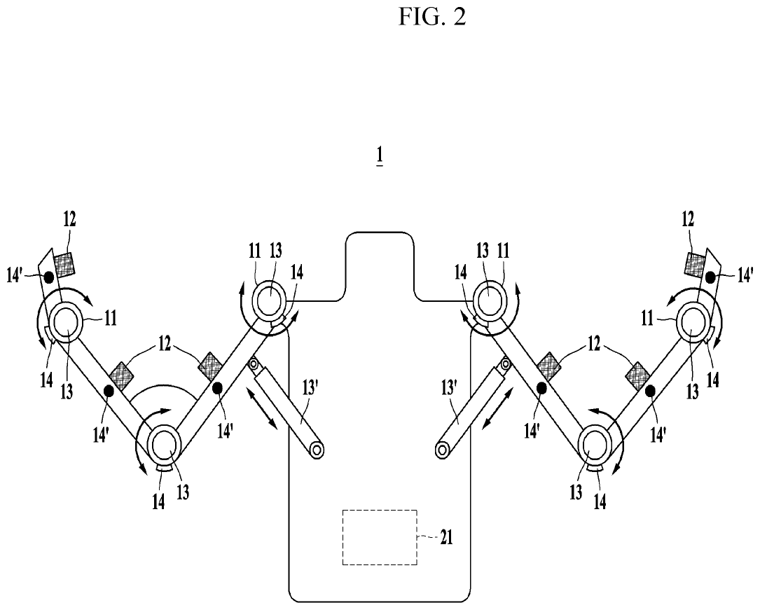

FIG. 2 is a conceptual diagram for explaining a rehabilitation robot for restoring upper musculoskeletal function according to the present disclosure.

Referring to FIG. 2, a rehabilitation robot 1 includes at least two joint portions 11, a plurality of body wearing portions 12 connected by the joint portions 11, a plurality of actuators 13 configured to rotate the plurality of body wearing portions 12 about the joint portions 11, a plurality of sensor modules 14 configured to measure joint torque generated by an external force applied by an operator or a patient, and a controller 21 configured to control operation of the actuators 13.

In this case, the rehabilitation robot 1 may be implemented in a wearable form attachable to a body of a patient, wherein the controller 21 is formed in a torso-shaped main body, and wherein the joint portions 11, the body wearing portions 12, the actuators 13, and the sensor modules 14 are provided on left and right sides of the main body corresponding to a right arm and a left arm, respectively.

Such a rehabilitation robot 1 may systematically perform rehabilitation treatment such that left and right arms of the patient are balanced through the controller 21.

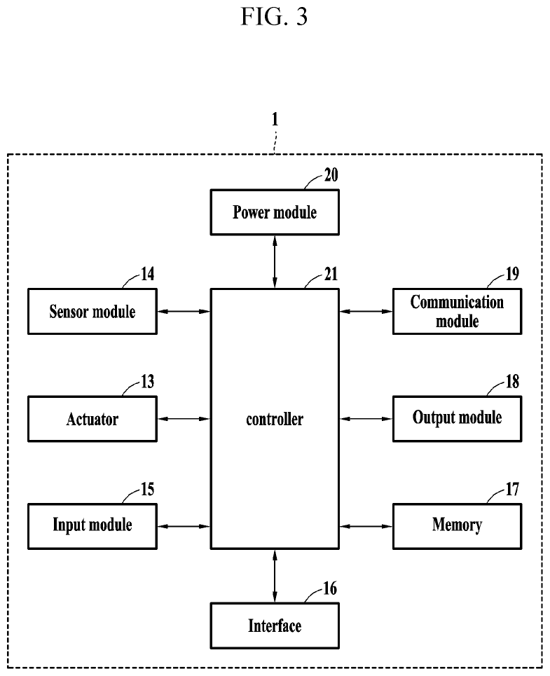

FIG. 3 is a block diagram illustrating an operating mechanism of a rehabilitation robot for restoring upper musculoskeletal function according to the present disclosure.

Referring to FIG. 3, the rehabilitation robot 1 according to the present disclosure may include an actuator 13, a sensor module 14, an input module 15, an interface 16, a memory 17, an output module 18, a communication module 19, a power module 20, and a controller 21.

The sensor module 14 may include an angle sensor, a motion detection sensor, a biosignal detection sensor, and the like, and may acquire data related to an angle of a joint, movement of a patient, and a state of the patient.

Meanwhile, joint torque measured by the sensor module 14 may be alternatively obtained by calculating an external force applied by an operator or a patient using a force measurement sensor 14′ installed in the body wearing portion 12 and converting the calculated external force into torque.

The actuator 13, under control of the controller 21, controls driving of the rehabilitation robot 1, that is, driving of each joint portion 11, such that a rehabilitation operation of the rehabilitation robot 1 is performed.

Further, the actuator 13 controls the rehabilitation robot to compensate for a weight of the rehabilitation robot and friction of the joint, and may, in some cases, operate to compensate joint torque generated by an external force applied by the operator or a wearer.

As shown in FIG. 2, the actuator 13 may include a stepping motor installed in each joint portion 11 or a combination of a stepping motor and a reducer.

Further, as shown in FIG. 2, a cylinder-type actuator 13′ configured to expand and contract in a longitudinal direction may also be used together.

The input module 15 generates key input data for controlling operation of the rehabilitation robot 1, and may be configured to receive commands or information through a push operation or a touch operation of a user.

Further, through the interface 16, the rehabilitation robot 1 may be communicatively connected to an external computer 300 to control or monitor the rehabilitation robot 1.

The memory 17 may store programs for processing and control of the controller 21 and may temporarily store input data or output data.

The output module 18 provides output functions of an audio signal, a video signal, and an alarm signal, and may include a display (not shown), an audio output module (not shown), and an alarm unit (not shown).

The communication module 19 provides a communication interface for wireless communication with a portable terminal (not shown), and may communicate wirelessly with the portable terminal through the communication module 19.

The power module 20 supplies power required for operation of respective components under control of the controller 21.

The controller 21 generally controls operations of the respective components and controls an overall operation of the rehabilitation robot 1.

The input module 15, the interface 16, the memory 17, the output module 18, the communication module 19, and the power module 20 may be integrally configured with the controller 21 in a single case, and these components may be installed in a main body of the rehabilitation robot 1 as shown in FIG. 2.

The rehabilitation robot 1 having such a configuration may be communicatively connected to a portable terminal or a computer through wired or wireless communication, and movement may be monitored or control commands for driving may be input through a screen displayed on the communicatively connected portable terminal or computer.

The portable terminal may include a mobile phone, a smart phone, a notebook computer, a tablet computer, an e-book terminal, and the like.

As described above, according to the present disclosure, in a state in which a patient wears a rehabilitation robot, an operator directly moves a plurality of joint portions to set a trainable joint range of motion of the patient, and set angle values measured at the plurality of joint portions are collectively stored in a controller, thereby enabling intuitive capture of rehabilitation operations. Accordingly, during operation of a multi-joint rehabilitation robot, angle values measured at the plurality of joint portions set to a maximum range of motion may be collectively stored and managed as a single set posture data value.

Accordingly, the present disclosure facilitates data input operations, reduces working time, and reduces costs associated therewith.

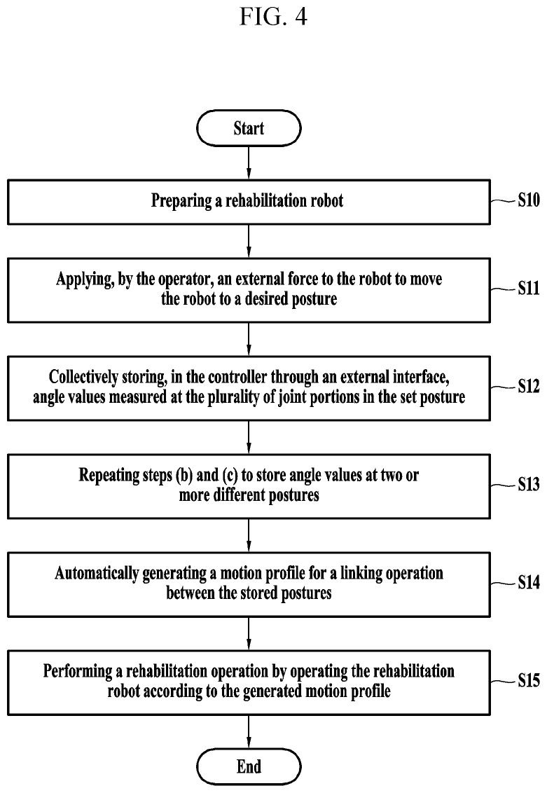

FIG. 4 is a flowchart illustrating a rehabilitation training method using a rehabilitation robot according to the present disclosure.

Referring to FIG. 4, first, a step of preparing a rehabilitation robot 1 (S10) is performed. In this case, the rehabilitation robot 1 may include at least two joint portions 11, a plurality of body wearing portions 12 connected by the joint portions 11, a plurality of actuators 13 configured to rotate the plurality of body wearing portions 12 about the joint portions 11, a plurality of sensor modules 14 configured to measure joint torque generated by an external force applied by an operator or a patient, and a controller 21 configured to control operation of the actuators 13.

When the rehabilitation robot 1 is prepared (S10), the operator applies an external force to the robot to move the robot to a desired posture (S11).

At this time, the patient may wear the robot and form a posture together with the operator. In this case, the operator may set the posture of the robot within a joint range of the patient while checking a condition of the patient.

A main body of the rehabilitation robot 1 may be formed in a shape of a torso of a human body. Thereafter, arms of the patient may be positioned on the plurality of body wearing portions 12 and secured with bands so as to be stably fixed during rehabilitation exercise.

According to the present disclosure, in a state in which a patient wears a rehabilitation robot, an operator having rehabilitation expertise directly checks a trainable joint range of motion of the patient by manipulating joint portions of the rehabilitation robot according to a condition of the patient, thereby enabling provision of a patient-specific rehabilitation protocol in terms of intensity, range, and method of rehabilitation exercise.

The present disclosure may selectively perform an operator mode in which operation of the robot is performed by an external force of the operator, a patient mode in which operation of the robot is performed by a patient's own force according to guidance of the operator, or a combination of the two modes.

Angle values measured at the plurality of joint portions in the set posture are collectively stored in the controller through an external interface (S12).

According to the present disclosure, in a state in which a patient wears a rehabilitation robot, an operator directly moves a plurality of joint portions to set a trainable joint range of motion of the patient, and set angle values measured at the plurality of joint portions are collectively stored in the controller, thereby providing an advantage in that rehabilitation operations and rehabilitation postures can be intuitively captured at once.

Further, after the rehabilitation robot 1 is prepared, step (b) of applying, by the operator, an external force to the robot to move the robot to a desired posture (S11) and step (c) of collectively storing, in the controller through an external interface, angle values measured at the plurality of joint portions in the set posture (S12) are repeatedly performed to perform step (d) of storing angle values at two or more different postures (S13).

According to the present disclosure, during operation of a multi-joint rehabilitation robot, angle values measured at the plurality of joint portions set to a maximum range of motion are collectively stored and managed as a single set posture data value, thereby reducing time required for data input and reducing costs associated therewith.

Thereafter, step (e) of automatically generating a motion profile for a linking operation between the stored postures (S14) is performed, and step (f) of performing a rehabilitation operation by operating the rehabilitation robot according to the generated motion profile (S15) is performed.

According to the present disclosure, in step (b) of applying, by the operator, an external force to the robot to move the robot to a desired posture (S11) after the rehabilitation robot 1 is prepared, torque values measured by the sensor modules 14 may be calculated, and compensation values of the actuators 13 may be set based on the torque values reflecting a variable corresponding to a body weight of the patient.

Further, torque values measured by the sensor modules 14 may be calculated, and compensation values of the actuators 13 may be set based on the torque values reflecting a variable corresponding to muscle strength of the patient.

Further, in the present disclosure, angle values measured during movement are not stored in order to obtain accurate data.

Further, step (f) of performing a rehabilitation operation by operating the rehabilitation robot (S15) may include selectively performing one of a forward operation mode in which the rehabilitation robot is operated according to an order of the generated motion profile and a reverse operation mode in which the rehabilitation robot is operated in a reverse order of the motion profile.

As described above, according to the present disclosure, in a state in which a patient wears a rehabilitation robot, an operator directly moves a plurality of joint portions to set a trainable joint range of motion of the patient, and set angle values measured at the plurality of joint portions are collectively stored in a controller, thereby providing an advantage in that rehabilitation operations can be intuitively captured, and linking operations and repetitive rehabilitation training among a plurality of rehabilitation operations captured by the controller can be performed, thereby significantly improving efficiency of rehabilitation exercise.

Further, according to the present disclosure, in a state in which a patient wears a rehabilitation robot, an operator having rehabilitation expertise manipulates joint portions of the rehabilitation robot according to a condition of the patient to check a trainable joint range of motion of the patient, thereby enabling provision of a patient-specific rehabilitation protocol in terms of intensity, range, and method of rehabilitation exercise, and thus improving efficiency of rehabilitation treatment.

Further, according to the present disclosure, during operation of a multi-joint rehabilitation robot, angle values measured at the plurality of joint portions set to a maximum range of motion are collectively stored and managed as a single set posture data value, thereby reducing time required for data input and reducing costs associated therewith.

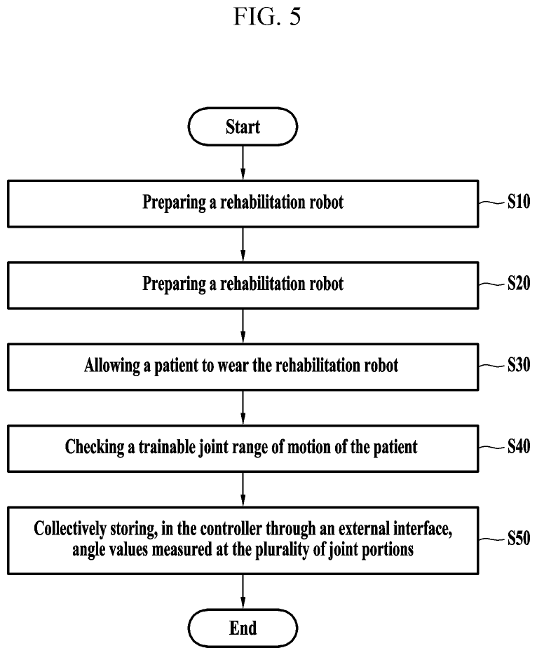

FIG. 5 is a flowchart illustrating a method for setting rehabilitation treatment angles of a plurality of joint portions of an upper limb rehabilitation robot according to the present disclosure.

Referring to FIG. 5, a method for setting rehabilitation treatment angles of a plurality of joint portions of an upper limb rehabilitation robot will be described.

First, an administrator performs a step of preparing a rehabilitation robot 1 (S10). In this case, the rehabilitation robot 1 may include at least two joint portions 11, a plurality of body wearing portions 12 connected by the joint portions 11, a plurality of actuators 13 configured to rotate the plurality of body wearing portions 12 about the joint portions 11, a plurality of sensor modules 14 configured to measure joint torque generated by an external force applied by an operator or a patient, and a controller 21 configured to control operation of the actuators 13.

When the rehabilitation robot 1 is prepared, an initialization step (S20) of calculating torque values measured by the sensor modules 14 and setting compensation values of the actuators 13 based on the calculated torque values is performed. Such an initialization step (S20) may be repeatedly performed for each rehabilitation treatment session.

In this case, in the initialization step (S20), torque values measured by the sensor modules 14 may be calculated, and compensation values of the actuators 13 may be set based on the torque values reflecting a variable corresponding to a body weight of the patient. Further, torque values measured by the sensor modules 14 may be calculated, and compensation values of the actuators 13 may be set based on the torque values reflecting a variable corresponding to muscle strength of the patient.

At this time, angle values measured during movement are not stored in order to obtain accurate data.

After completion of the initialization step (S20), a step of allowing a patient to wear the rehabilitation robot 1 (S30) is performed. In this case, a main body of the rehabilitation robot 1 may be formed in a shape of a torso of a human body, and arms of the patient may be positioned on the plurality of body wearing portions 12 and secured with bands so as to be stably fixed during rehabilitation exercise.

Thereafter, when wearing of the rehabilitation robot 1 is completed, a step (S40) of checking a trainable joint range of motion of the patient is performed while an operator rotates the joint portions of the robot through interaction with the patient.

According to the present disclosure, in a state in which a patient wears a rehabilitation robot, an operator having rehabilitation expertise directly checks a trainable joint range of motion of the patient by manipulating the joint portions of the rehabilitation robot according to a condition of the patient, thereby enabling provision of a patient-specific rehabilitation protocol in terms of intensity, range, and method of rehabilitation exercise.

The present disclosure may selectively perform an operator mode in which operation of the robot is performed by an external force of the operator, a patient mode in which operation of the robot is performed by a patient's own force according to guidance of the operator, or a combination of the two modes.

When the trainable joint range of motion of the patient is determined, a step (S50) of collectively storing, in the controller 21 through an external interface, angle values measured at the plurality of joint portions 11 is performed.

By performing the above-described processes, the present disclosure may provide a method for setting rehabilitation treatment angles of a plurality of joint portions of an upper limb rehabilitation robot.

According to the present disclosure, in a state in which a patient wears a rehabilitation robot, an operator directly moves a plurality of joint portions to set a trainable joint range of motion of the patient, and set angle values measured at the plurality of joint portions are collectively stored in the controller, thereby providing an advantage in that rehabilitation operations and rehabilitation postures can be intuitively captured at once.

Accordingly, the present disclosure enables various rehabilitation treatments to be performed by applying the method for setting rehabilitation treatment angles of a plurality of joint portions of the upper limb rehabilitation robot.

For example, by repeatedly performing the step (S40) of checking a trainable joint range of motion of the patient while rotating the joint portions of the robot through interaction between the operator and the patient and the step (S50) of collectively storing, in the controller 21 through an external interface, angle values measured at the plurality of joint portions 11, angle values at two or more different postures may be stored, which may be effectively applied during operation of a multi-joint rehabilitation robot.

In other words, according to the present disclosure, angle values measured at the plurality of joint portions set to a maximum range of motion of the patient may be collectively stored and managed as a single set posture data value, thereby reducing time required for data input and reducing costs associated therewith.

Further, according to the present disclosure, the controller 21 may generate a motion profile for a linking operation between the stored postures and operate the rehabilitation robot according to the generated motion profile to perform a rehabilitation operation. In this case, one of a forward operation mode in which the rehabilitation robot is operated according to an order of the generated motion profile and a reverse operation mode in which the rehabilitation robot is operated in a reverse order of the motion profile may be selectively performed.

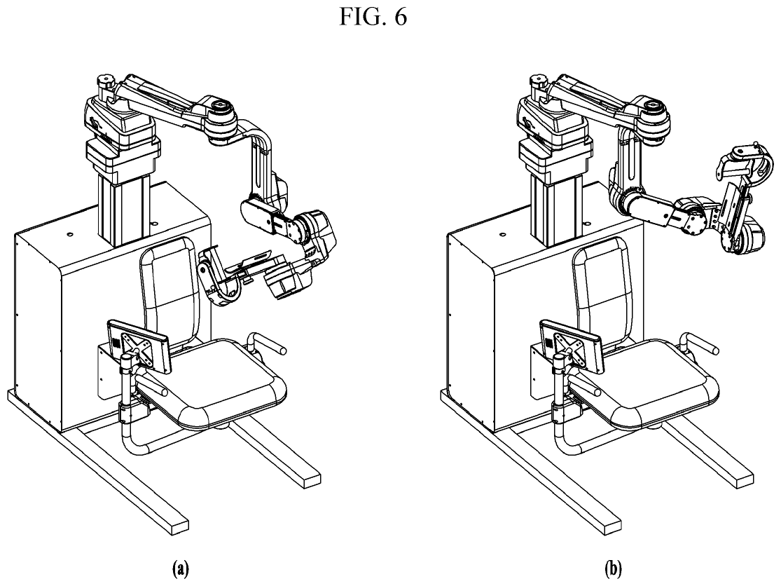

FIG. 6 is a diagram illustrating an example of a transformed robot posture.

Referring to FIG. 6, two or more different robot postures may be automatically transformed by repeating step (d) and step (e). That is, a robot posture may be automatically transformed from (a) to (b), which are different robot postures.

As described above, although embodiments have been described with reference to a limited number of drawings, various modifications and variations may be made by those skilled in the art based on the above description. For example, the described techniques may be performed in a different order from the described method, and/or components of the described system, structure, apparatus, or circuit may be combined or configured in a different form from the described method, or may be replaced or substituted with other components or equivalents, and appropriate results may still be achieved.

Accordingly, other implementations, other embodiments, and equivalents to the claims fall within the scope of the appended claims.

The present disclosure has an effect of improving efficiency of rehabilitation exercise by allowing an operator, in a state in which a patient wears a rehabilitation robot, to directly move a plurality of joint portions to set a trainable joint range of motion of the patient, and by collectively storing, in a controller, set angle values measured at the plurality of joint portions, thereby enabling intuitive capture of rehabilitation operations and enabling linking operations and repetitive rehabilitation training among a plurality of rehabilitation operations captured by the controller.

Further, the present disclosure has an effect of providing a patient-specific rehabilitation protocol by allowing an operator having rehabilitation expertise, in a state in which a patient wears a rehabilitation robot, to manipulate joint portions of the rehabilitation robot according to a condition of the patient to check a trainable joint range of motion of the patient, thereby determining an intensity, a range, and a method of rehabilitation exercise according to the patient.

Further, the present disclosure has an effect of reducing time required for data input and reducing costs associated therewith by collectively storing and managing angle values measured at a plurality of joint portions set to a maximum range of motion as a single set posture data value during operation of a multi-joint rehabilitation robot.

What is claimed is:

1. A rehabilitation training method for a rehabilitation robot for restoring upper musculoskeletal function, the method comprising:
(a) preparing a rehabilitation robot including at least two joint portions, a plurality of body wearing portions connected by the joint portions, a plurality of actuators configured to rotate the plurality of body wearing portions about the joint portions, a plurality of sensor modules configured to measure joint torque generated by an external force applied by an operator or a patient, and a controller configured to control operation of the actuators (S10);
(b) applying, by the operator, an external force to the robot to move the robot to a desired posture (S11);
(c) collectively storing, in the controller through an external interface, angle values measured at the plurality of joint portions in the set posture (S12);
(d) repeating steps (b) and (c) to store angle values at two or more different postures (S13);
(e) automatically generating a motion profile for a linking operation between the stored postures (S14); and
(f) performing a rehabilitation operation by operating the rehabilitation robot according to the generated motion profile (S15).

2. The method of claim 1, wherein step (b) includes performing an operator mode in which operation of the robot is performed by the external force of the operator.

3. The method of claim 1, wherein step (b) includes performing a patient mode in which operation of the robot is performed by a patient's own force according to guidance of the operator.

4. The method of claim 1, wherein, in step (c), angle values measured during movement are not stored.

5. The method of claim 1, wherein step (f) includes selectively performing one of a forward operation mode in which the rehabilitation robot is operated according to an order of the generated motion profile and a reverse operation mode in which the rehabilitation robot is operated in a reverse order of the motion profile.

6. A method for setting rehabilitation treatment angles of a plurality of joint portions of an upper limb rehabilitation robot, the method comprising:
(a) preparing a rehabilitation robot including at least two joint portions, a plurality of body wearing portions connected by the joint portions, a plurality of actuators configured to rotate the plurality of body wearing portions about the joint portions, a plurality of sensor modules configured to measure joint torque generated by an external force applied by an operator or a patient, and a controller configured to control operation of the actuators (S10);
(b) performing an initialization step of calculating torque values measured by the sensor modules and setting compensation values of the actuators based on the calculated torque values (S20);
(c) allowing a patient to wear the rehabilitation robot (S30);
(d) checking a trainable joint range of motion of the patient while rotating the joint portions of the robot through interaction between the operator and the patient (S40); and
(e) collectively storing, in the controller through an external interface, angle values measured at the plurality of joint portions when the trainable joint range of motion of the patient is determined (S50).

7. The method of claim 6, wherein the rehabilitation robot is implemented in a wearable form attachable to a body of the patient,
wherein the controller is formed in a torso-shaped main body,
wherein joint portions, wearing portions, actuators, and sensor modules are respectively provided on left and right sides of the main body corresponding to a right arm and a left arm, and
wherein rehabilitation treatment is systematically performed such that left and right arms of the patient are balanced through the controller.

8. The method of claim 6, wherein the rehabilitation robot includes an actuator, a sensor module, an input module, an interface, a memory, an output module, a communication module, a power module, and a controller, and
wherein the input module, the interface, the memory, the output module, the communication module, and the power module are integrally configured with the controller in a single case and installed in a main body of the rehabilitation robot.

9. The method of claim 6, wherein step (d) includes performing an operator mode in which operation of the robot is performed by an external force of the operator.

10. The method of claim 6, wherein step (d) includes performing a patient mode in which operation of the robot is performed by a patient's own force according to guidance of the operator.

11. The method of claim 6, wherein step (b) or step (c) includes calculating torque values measured by the sensor modules and setting compensation values of the actuators based on the torque values reflecting a variable corresponding to a body weight of the patient.

12. The method of claim 6, wherein step (b) or step (c) includes calculating torque values measured by the sensor modules and setting compensation values of the actuators based on the torque values reflecting a variable corresponding to muscle strength of the patient.
